(19) United States
(12) Patent Application Publication
(10) Pub. No.: US 2012/0264401 A1
(43) Pub. Date: Oct. 18, 2012

(54) SYSTEM AND METHOD FOR AUTHENTICATING MOBILE TERMINAL

(75) Inventor: Ji Hun HWANG, Seoul (KR)

(73) Assignee: LSIS CO., LTD., Anyang-si (KR)

(21) Appl. No.: 13/425,323

(22) Filed: Mar. 20, 2012

(30) Foreign Application Priority Data
Apr. 12, 2011 (KR) 10-2011-0033880

(51) Int. Cl. H04W 12/06

(52) U.S. Cl. 455/411

(57) ABSTRACT

Provided is a system employed for authentication of a mobile terminal and a method using the same, wherein the method is such that an authentication code is received from a tag using a first communication type through a second communication type using a substantially same frequency band as that of the first communication type, and the authentication code is transmitted to a server of a mobile service provider to perform the authentication.

### CROSS REFERENCE TO RELATED APPLICATIONS

Pursuant to 35 U.S.C. §119 (a), this application claims the benefit of earlier filing date and right of priority to Korean Patent Application No. 10-2011-0033880, filed on Apr. 12, 2011, the contents of which is hereby incorporated by reference in their entirety.

### BACKGROUND OF THE DISCLOSURE

1. Field of Endeavor

The present disclosure relates to a system and method for authentication, and more particularly to a system employed for authentication of a mobile terminal and a method using the same.

2. Background

Generally, a user must go through an authentication process to newly activate a mobile terminal. FIG. 1 is an exemplary view illustrating an authentication process of a mobile terminal according to prior art.

In a case a user applies a power to a new mobile terminal (100), a relay (200) receives a signal from the mobile terminal (100) and recognizes that the relevant mobile terminal 100 is a mobile terminal requiring an authentication.

Under this circumstance, when the user (or a seller) inputs a PIN (Personal Identification Number), the relay 200 transmits the occurrence to a server (300) of a mobile service provider, which performs an authentication to the relevant mobile terminal (100). The mobile terminal (100) can now receive a service provided by the server (300) of the mobile service provider following this process.

However, the authentication process is problematic because a user cannot directly get the service without participation by a distributor of the mobile service provider. Thus, another problem is that it takes time to get served, because the user can use the mobile terminal only through the authentication after purchase of the mobile terminal.

### SUMMARY

The present disclosure has been made to solve the foregoing problems of the prior art and therefore an object of certain embodiments of the present invention is to provide a system for authentication of a mobile terminal configured to allow a user to get the authentication immediately after purchase of the mobile terminal, and a method using the same.

In one general aspect of the present disclosure, there is provided an apparatus for authentication of a mobile terminal in which the mobile terminal transmits an authentication code to a server of a mobile service provider, the apparatus comprising: a tag for storing the authentication code and transmitting the authentication code to the mobile terminal using a first communication type; and the mobile terminal for receiving the authentication code using a second communication type using a substantially same frequency band as that of the first communication type and transmitting the received authentication code to the server of the mobile service provider using a predetermined third communication type.

Preferably, but not necessarily, the tag comprises a first storage for storing the authentication code, and a first communication unit for transmitting the authentication code to the mobile terminal using the first communication type.

Preferably, but not necessarily, the mobile terminal comprises a second communication unit for receiving the authentication code using the second communication type, and a controller controllably transmitting the authentication code received by the second communication unit to the server of the mobile service provider.

Preferably, but not necessarily, the mobile terminal further comprises a second storage for storing an application for authentication, and the controller drives the application to guide a user to approach the tag to the mobile terminal.

Preferably, but not necessarily, the mobile terminal further comprises a third communication unit transmitting the authentication code to the server of the mobile service provider using the third communication type in response to control of the controller.

In another general aspect of the present disclosure, there is provided an apparatus for authentication of a mobile terminal configured to receive an authentication code from a tag stored with the authentication code and transmitting the authentication code to a server of a mobile service provider, the apparatus comprising: a communication unit receiving the authentication code from the tag; and a controller transmitting the authentication code received by the communication unit to the server of the mobile service provider through a predetermined network.

Preferably, but not necessarily, the apparatus further comprises a storage for storing an application for guiding reception of the authentication code.

Preferably, but not necessarily, the controller drives the application to guide a user to approach the tag.

Preferably, but not necessarily, the communication type of the tag and that of the communication unit are substantially same.

Preferably, but not necessarily, the communication type of the tag and that of the communication unit are different, and use substantially same frequency band.

In another general aspect of the present disclosure, there is provided a method for authentication of a mobile terminal, the method comprising: receiving an authentication code from a tag using a first communication type through a second communication type using a substantially same frequency band as that of the first communication type; and performing the authentication by transmitting the authentication code to a server of a mobile service provider.

Preferably, but not necessarily, the first communication type is an RFID, while the second communication type is an NFC.

The present disclosure has an advantageous effect in that an authentication of a mobile terminal can be simply performed by receiving an authentication code stored in an RFID tag by activating an NFC application, whereby a purchaser can individually perform the authentication of the mobile terminal used to be performed by a distributer to thereby promote the user convenience, and one RFID tag is issued to one mobile terminal for one authentication to allow an immediate measure to be taken when there is a theft or a loss of the mobile terminal.

### BRIEF DESCRIPTION OF THE DRAWINGS

The drawing figures depict one or more exemplary embodiments in accord with the present concepts, by way of example only, not by way of limitations. In the figures, like reference numerals refer to the same or similar elements.

Thus, a wide variety of potential practical and useful embodiments will be more readily understood through the following detailed description of certain exemplary embodiments, with reference to the accompanying exemplary drawings in which:

FIG. 1 is an exemplary view illustrating an authentication process of a mobile terminal according to prior art;

FIG. 2 is a conceptual view illustrating a system for authentication of a mobile terminal according to the present disclosure;

FIG. 3 is a detailed conceptual block diagram illustrating an RFID tag of FIG. 2 according to an exemplary embodiment of the present disclosure;

FIG. 4 is a structural block diagram of an apparatus for authentication of a mobile terminal of FIG. 2 according to an exemplary embodiment of the present disclosure;

FIGS. 5A to 5E are schematic views illustrating a method for authentication of a mobile terminal in a system for authentication of the mobile terminal according to an exemplary embodiment of the present disclosure; and

FIG. 6 is a flowchart of a method for authentication of a mobile terminal according to the present disclosure.

### DETAILED DESCRIPTION

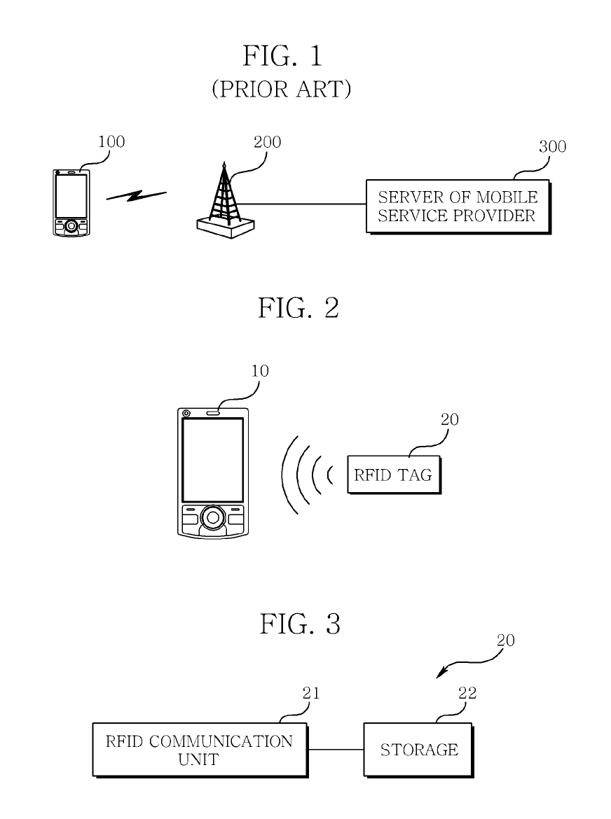

The disclosed embodiments and advantages thereof are best understood by referring to FIGS. 1-6 of the drawings, like numerals being used for like and corresponding parts of the various drawings. Other features and advantages of the disclosed embodiments will be or will become apparent to one of ordinary skill in the art upon examination of the following figures and detailed description. It is intended that all such additional features and advantages be included within the scope of the disclosed embodiments, and protected by the accompanying drawings. Further, the illustrated figures are only exemplary and not intended to assert or imply any limitation with regard to the environment, architecture, or process in which different embodiments may be implemented. Accordingly, the described aspect is intended to embrace all such alterations, modifications, and variations that fall within the scope and novel idea of the present invention.

Meanwhile, the terminology used herein is for the purpose of describing particular implementations only and is not intended to be limiting of the present disclosure. The terms “first,” “second,” and the like, herein do not denote any order, quantity, or importance, but rather are used to distinguish one element from another. For example, a second constituent element may be denoted as a first constituent element without departing from the scope and spirit of the present disclosure, and similarly, a first constituent element may be denoted as a second constituent element.

As used herein, the terms “a” and “an” herein do not denote a limitation of quantity, but rather denote the presence of at least one of the referenced item. That is, as used herein, the singular forms “a”, “an” and “the” are intended to include the plural forms as well, unless the context clearly indicates otherwise.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Also, “exemplary” is merely meant to mean an example, rather than the best. If is also to be appreciated that features, layers and/or elements depicted herein are illustrated with particular dimensions and/or orientations relative to one another for purposes of simplicity and ease of understanding, and that the actual dimensions and/or orientations may differ substantially from that illustrated.

That is, in the drawings, the size and relative sizes of layers, regions and/or other elements may be exaggerated or reduced for clarity. Like numbers refer to like elements throughout and explanations that duplicate one another will be omitted. As may be used herein, the terms “substantially” and “approximately” provide an industry-accepted tolerance for its corresponding term and/or relativity between items.

The present disclosure uses a same frequency band of RFID (Radio Frequency Identification) in HF (High Frequency) band as that of NFC (Near Field Communication). Although the present disclosure has explained the RFID and NFC, it should be apparent to the skilled in the art that other communication methods using a frequency of same frequency band are not ruled out. Furthermore, it should be also apparent to the skilled in the art that the authentication of the present disclosure can be performed by a same communication type, in addition to the other communication type.

Hereinafter, the present disclosure will be described in detail with reference to the accompanying drawings.

FIG. 2 is a conceptual view illustrating a system for authentication of a mobile terminal according to the present disclosure.

Referring to FIG. 2, a system for authentication of a mobile terminal includes a mobile terminal (10) and an RFID tag (20). Generally, in a case a user purchases the mobile terminal (10), the RFID tag (20) according to the present disclosure is also provided to the user along with the mobile terminal (10).

The mobile terminal (10) according to the present disclosure includes a portable terminal, a smart phone, a tablet computer, a digital broadcasting terminal, a PDA (Personal Digital Computer), and a PMP (Portable Multimedia Player), and is generally referred to a portable terminal that needs an authentication for communication with a server. The mobile terminal (10) according to the present disclosure comprises an NFC communication unit for enabling an NFC communication, a detailed description of which will be provided later with reference to accompanying drawings.

FIG. 3 is a detailed conceptual block diagram illustrating an RFID tag of FIG. 2 according to an exemplary embodiment of the present disclosure.

Referring to FIG. 2, the RFID tag (20) according to the present disclosure includes an RFID communication unit (21) and storage (22). It should be noted that only the constituent parts related to operation of the present disclosure will be described, and other constituent parts generally used for an RFID tag is obvious to the skilled in the art, such that a detailed description thereto will be omitted herefrom. The RFID communication unit (21) performs an RFID communication at an HF band. The RFID communication unit (21) of HF band generally performs a communication using a frequency in 13.56 MHz band. The RFID communication unit (21) according to the present disclosure transmits data to the mobile terminal (10) according to an RFID, in a case a data for authentication is requested from the mobile terminal (10).

The storage (22) stores authentication code for authentication of the mobile terminal (10). A manufacturer of the mobile terminal (10) may store a relevant authentication code in the storage (22) of the RFID tag (20) during manufacturing of the mobile terminal (10).

FIG. 4 is a structural block diagram of an apparatus for authentication of a mobile terminal of FIG. 2 according to an exemplary embodiment of the present disclosure, where the apparatus is embedded in the mobile terminal (10).

Referring to FIG. 4, the apparatus for authentication of a mobile terminal includes an NFC communication unit (11), a controller (12) and storage (13). The apparatus is embedded in the mobile terminal (10), and particularly refers to an apparatus for authentication of a mobile terminal relative to the constituent parts in FIG. 4 and obvious to the skilled in art such that further description thereto will be omitted.

In general, NFC is a non-contact near field wireless communication type using 13.56 MHz frequency band, and refers to a technology capable of bi-directionally transmitting data at a short distance of 10 cm with low power consumption. Thus, the NFC communication unit (11) can receive and transmit a signal of NFC frequency band. To be more specific, the NFC communication unit (11) receives from the RFID tag (20) an authentication code stored in the storage (22) using the NFC communication type in response to the control of the controller (12).

The controller (12) controls an overall authentication process of the present disclosure. The controller (12) may control the storage (13) to store an NFC application for authentication in order to operate the present disclosure.

In a case a user wants an authentication of the mobile terminal (10), the controller (12) activates the NFC application stored in the storage (13). The controller (12) controls the NFC communication unit (11) in accordance with the activation of the NFC application, communicates with the RFID communication unit (21) and receives the authentication code stored in the storage (22) of the RFID tag (20).

Successively, the controller (12) transmits the received authentication code to a server (300) of a mobile service provider illustrated in FIG. 1, for example, where the server (300) of the mobile service provider performs the authentication of a relevant mobile terminal (10), and where the mobile terminal (10) can use the mobile communication service provided by the server (300) of the mobile service provider.

At this time, the mobile terminal (10) may use a predetermined network (e.g., CDMA, Code Division Multiple Access) in order to transmit the received authentication to the server (300) of the mobile service provider, and to this end, the apparatus may further include a communication unit (not shown) for communicating with the predetermined network.

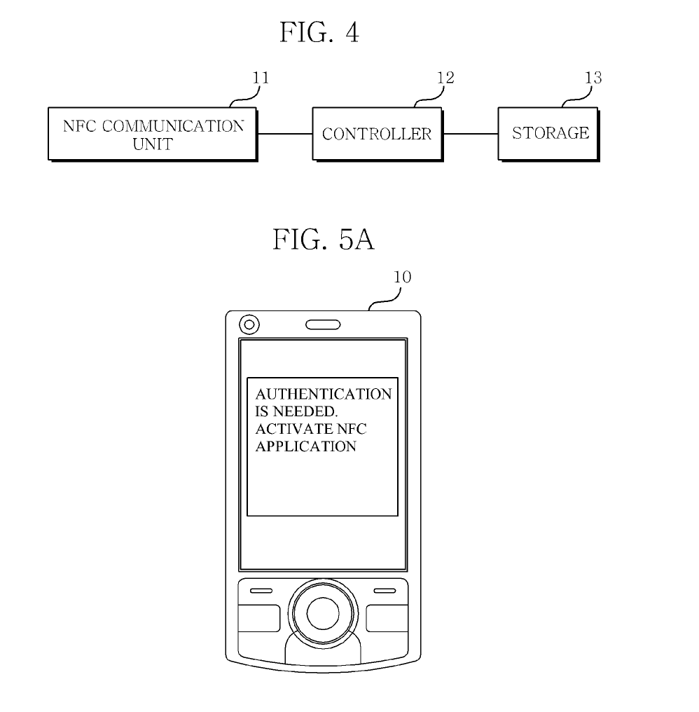

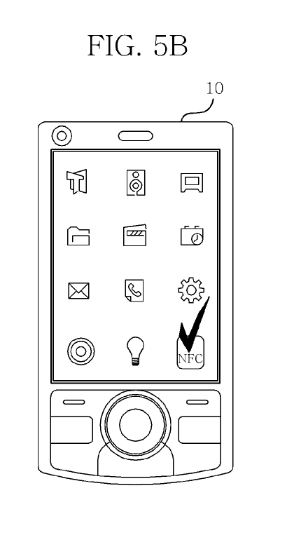

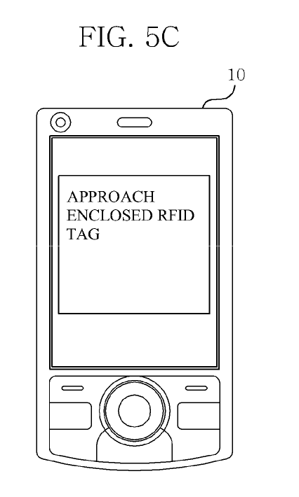

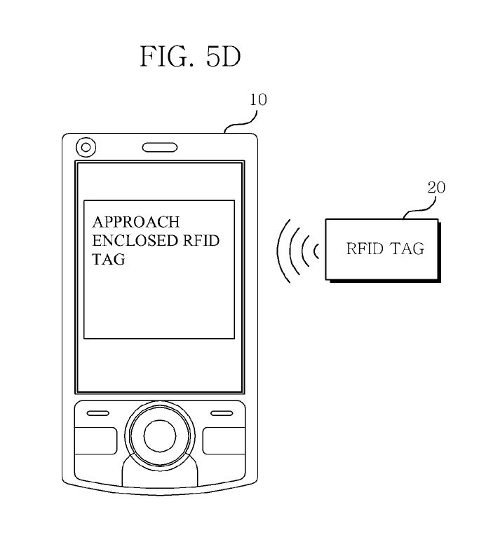

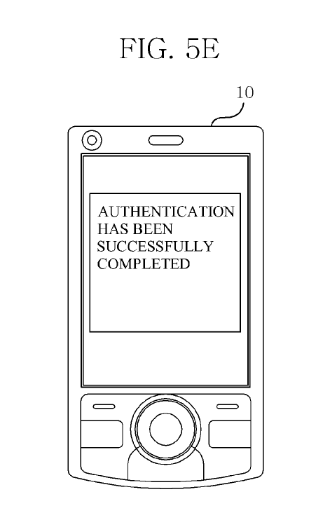

FIGS. 5A to 5E are schematic views illustrating a method for authentication of a mobile terminal in a system for authentication of the mobile terminal according to an exemplary embodiment of the present disclosure.

Referring to FIG. 5A, in a case a user purchases a mobile terminal (10) and applies a power source to the mobile terminal (10), the controller (12) notifies to the user that a relevant mobile terminal (10) needs an authentication through a display unit of the mobile terminal (10), and notifies to the user to activate the NFC application for authentication.

Thereafter, as shown in FIG. 5B, the user activates the NFC application on a menu. A check mark (√) in FIG. 5B indicates that the user has selected a relevant NFC application using a pointing device (e.g., finger of the user). It should be apparent to the skilled in the art that the activation of the NFC application means that a relevant communication unit has been activated to receive data through NFC.

Then, as shown in FIG. 5C, the NFC application may request the user to approach the enclosed RFID tag (20) for authentication. However, this is an example for authentication, and it should be also apparent that the NFC application is not used solely for the authentication.

That is, a UI (User Interface) as illustrated in FIG. 5C may be realized only in a case authentication of a relevant mobile terminal (10) has not been completed, or an NFC application may be separately mounted only for the authentication to provide the UI as shown in FIG. 5C.

Thereafter, in a case the user approaches the RFID tag (20) to the mobile terminal (10) as depicted in FIG. 5D, the controller (12) of the mobile terminal (10) receives the authentication code stored in the storage (22) of the RFID tag (20) through the NFC communication unit (11) of the mobile terminal (10) and the RFID communication unit (21), and transmits to the server (300) of the mobile service provider through a communication unit (not shown) to complete the authentication of the relevant mobile terminal (10). In a case the authentication thus described is finished, a UI as illustrated in FIG. 5E is provided to notify the user that the authentication has been completed. Thereafter, the user can use the service of the mobile terminal.

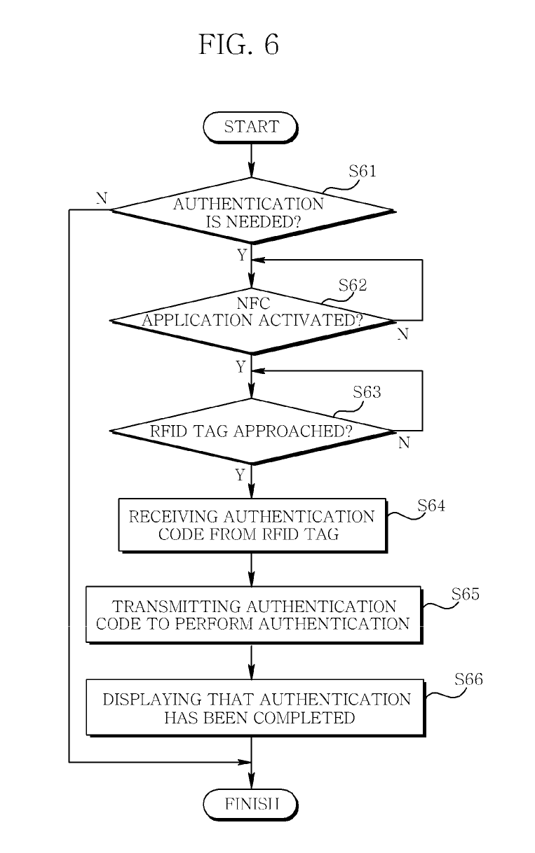

FIG. 6 is a flowchart of a method for authentication of a mobile terminal according to the present disclosure.

Referring to FIG. 6, the method for authentication of a mobile terminal includes activating, by a user, an NFC application (S62), in case there is a request (S61) for authentication after purchase of a mobile terminal (10), to guide an approach of the enclosed RFID tag (20) as shown in FIG. 5C. In a case the user approaches the RFID tag (20) to the mobile terminal (10) (S63), the controller (12) receives the authentication code stored in the storage (22) of the RFID tag (20) through the RFID communication unit (21) and the NFC communication unit (11).

Successively, the relevant authentication code is transmitted to the server (300) of the mobile service provider through a communication unit (not shown) to allow the authentication of the relevant mobile terminal (S65), and in a case the authentication is completed, the completion of the authentication may be displayed on a display unit of the mobile terminal (10) (S66).

The present disclosure has described that the frequency band of the RFID at HF band and the NFC frequency band are same. Although the present disclosure has exemplified the RFID and NFC cases, it should be apparent that other communication types using the same frequency band cannot be ruled out, as explained above.

Although the present disclosure has been described with reference to a number of illustrative embodiments thereof, it should be understood that numerous other modifications and embodiments can be devised by those skilled in the art that will fall within the spirit and scope of the principles of this disclosure.

More particularly, various variations and modifications are possible in the component parts and/or arrangements of subject combination arrangement within the scope of the disclosure, the drawings and the appended claims. In addition to variations and modifications in the component parts and/or arrangements, alternative uses will also be apparent to those skilled in the art.

What is claimed is:

1. A system for authentication of a mobile terminal in which the mobile terminal transmits an authentication code to a server of a mobile service provider, the system comprising: a tag for storing the authentication code and transmitting the authentication code to the mobile terminal using a first communication type; and the mobile terminal for receiving the authentication code using a second communication type using a substantially same frequency band as that of the first communication type and transmitting the received authentication code to the server of the mobile service provider using a predetermined third communication type.

2. The apparatus of claim 1, wherein the tag comprises a first storage for storing the authentication code, and a first communication unit for transmitting the authentication code to the mobile terminal using the first communication type.

3. The apparatus of claim 1, wherein the mobile terminal comprises a second communication unit for receiving the authentication code using the second communication type, and a controller controllably transmitting the authentication code received by the second communication unit to the server of the mobile service provider.

4. The apparatus of claim 3, wherein the mobile terminal further comprises a second storage for storing an application for authentication, and the controller drives the application to guide a user to approach the tag to the mobile terminal.

5. The apparatus of claim 4, wherein the mobile terminal further comprises a third communication unit transmitting the authentication code to the server of the mobile service provider using the third communication type in response to control of the controller.

6. An apparatus for authentication of a mobile terminal configured to receive an authentication code from a tag storing the authentication code and transmitting the authentication code to a server of a mobile service provider, the apparatus comprising: a communication unit receiving the authentication code from the tag; and a controller transmitting the authentication code received by the communication unit to the server of the mobile service provider through a predetermined network.

7. The apparatus of claim 6, further comprising a storage for storing an application for guiding reception of the authentication code.

8. The apparatus of claim 7, wherein the controller drives the application to guide a user to approach the tag.

9. The apparatus of claim 6, wherein the communication type of the tag and that of the communication unit are substantially same.

10. The apparatus of claim 6, wherein the communication type of the tag and that of the communication unit are different, and use substantially same frequency band.

11. A method for authentication of a mobile terminal, the method comprising: receiving an authentication code from a tag using a first communication type through a second communication type using a substantially same frequency band as that of the first communication type; and performing the authentication by transmitting the authentication code to a server of a mobile service provider.

12. The method of claim 11, wherein the first communication type is an RFID, while the second communication type is an NFC.
